(19) United States
(12) Patent Application Publication
(10) Pub. No.: US 2025/0210888 A1
(43) Pub. Date: Jun. 26, 2025

(54) TERMINAL BLOCK

(71) Applicant: YAZAKI CORPORATION, Tokyo (JP)

(72) Inventor: Atsunori Iwashita, Makinohara-shi (JP)

(21) Appl. No.: 18/970,799

(22) Filed: Dec. 5, 2024

(30) Foreign Application Priority Data
Dec. 25, 2023 (JP) 2023-218111

(51) Int. Cl. H01R 9/22; H01R 9/24

(52) U.S. Cl. CPC H01R 9/223; H01R 9/24

(57) ABSTRACT

A terminal block includes a plurality of terminals, a housing, a plurality of covers pivotally supported by the housing, each having a pivot shaft and configured to be pivotable, and a restriction member. A meshing portion is provided on the pivot shaft and configured to mesh with each of a plurality of meshed portions provided on the restriction member. When all of the plurality of the covers are in closed positions, the restriction member is positioned in an initial position where each of the plurality of meshed portions is able to mesh with the meshing portion. When a first cover of the plurality of the covers pivots, the meshing portion of the first cover meshes with the meshed portion, and the restriction member is displaced, thereby making the meshing portion in the plurality of the covers other than the first cover unable to mesh with the meshed portion.

### CROSS-REFERENCE TO RELATED APPLICATIONS

This application is based on and claims priority under 35 USC 119 from Japanese Patent Application No. 2023-218111 filed on Dec. 25, 2023.

### TECHNICAL FIELD

The present disclosure relates to a terminal block.

### BACKGROUND ART

In the related art, there has been proposed a terminal block that includes a plurality of terminals to be respectively connected to counterpart terminals, a housing that includes a plurality of operation openings corresponding to the plurality of terminals, and a plurality of opening and closing covers capable of opening and closing the respective operation openings. This type of terminal block is often used in an environment of a large current, a high voltage, or the like, and is configured such that the plurality of terminals (specifically, contacts with counterpart members) cannot be simultaneously touched from viewpoints of safety (electric shock prevention or the like) and short-circuit prevention.

For example, Patent Literature 1 discloses a terminal block that includes: a pair of terminals, a housing that includes a pair of operation openings, and a pair of opening and closing covers, in which one opening and closing cover of the pair of opening and closing covers is opened by falling toward the other opening and closing cover of the pair of opening and closing covers, while the other opening and closing cover remains closed. That is, in the terminal block of Patent Literature 1, the pair of opening and closing covers are prevented from being simultaneously opened, and the pair of terminals cannot be simultaneously touched.

### CITATION LIST

### Patent Literature

Patent Literature 1: JP2023-122740A

### SUMMARY OF INVENTION

However, in the terminal block of Patent Literature 1, when three or more terminals are provided, two or more opening and closing covers can be simultaneously opened due to the structure, which may unintentionally result in simultaneously a plurality of terminals being touched. Therefore, when a plurality of (particularly three or more) terminals are provided, it is desirable to have a configuration in which two or more opening and closing covers cannot be simultaneously opened.

The present disclosure has been made in view of the above circumstances, and an object thereof is to provide a terminal block in which when one cover is opened or is opening, other covers can be appropriately prevented from opening.

In order to achieve the above object, a terminal block according to the present disclosure has the following features.

A terminal block includes:
a plurality of terminals connected to counterpart terminals;
a housing provided with a plurality of openings corresponding to the plurality of terminals;
a plurality of covers pivotally supported by the housing, each having a pivot shaft and configured to be pivotable around the pivot shaft between an open position and a closed position with respect to each of the plurality of openings; and
a restriction member accommodated in the housing and configured to restrict, in response to pivoting of a first cover of the plurality of the covers in an opening direction, pivoting of the plurality of the covers other than the first cover in the opening direction. A meshing portion is provided on the pivot shaft, the meshing portion configured to mesh with each of a plurality of meshed portions provided on the restriction member,
only when the meshing portion meshes with the meshed portion, the plurality of the covers are pivotable from the closed position to the open position,
when all of the plurality of the covers are in the closed positions, the restriction member is positioned in an initial position where each of the plurality of meshed portions is able to mesh with the meshing portion, and
when the first cover pivots in the opening direction, the meshing portion of the first cover meshes with the meshed portion, and in response to the pivoting of the first cover from the closed position to the open position, the restriction member is displaced in an axial direction of the pivot shaft from the initial position, thereby making the meshing portion in the plurality of the covers other than the first cover unable to mesh with the meshed portion

According to the present disclosure, when all of the plurality of covers are in the closed positions to close the openings, the restriction member is positioned in the initial position where each of the plurality of meshed portions is able to mesh with the meshing portion, and when the first cover pivots in the opening direction, the meshing portion of the first cover meshes with the meshed portion, and in response to the pivoting of the first cover from the closed position to the open position, the restriction member is displaced in an axial direction of the pivot shaft from the initial position, thereby making the meshing portion in the plurality of the covers other than the first cover unable to mesh with the meshed portion. Since the cover is pivotable from the closed position to the open position only when the meshing portion meshes with the meshed portion, the plurality of covers other than the first cover cannot pivot from the closed positions to the open positions. That is, according to the present disclosure, when the first cover is opened or is opening, the plurality of covers other than the first cover can be appropriately prevented from opening.

The present disclosure has been briefly described above. Details of the present disclosure can be clarified by reading a mode (hereinafter, referred to as an “embodiment”) for carrying out the invention to be described below with reference to the accompanying drawings.

### BRIEF DESCRIPTION OF DRAWINGS

FIG. 1 is a perspective view illustrating an aspect in which all of a plurality of covers are in closed positions in a terminal block according to an embodiment of the present disclosure;

FIG. 2 is a perspective view illustrating an aspect in which one cover is in an open position in the terminal block illustrated in FIG. 1;

FIG. 3 is an exploded perspective view of a main portion of the terminal block illustrated in FIG. 1;

FIG. 4 is a top view of the terminal block illustrated in FIG. 1;

FIG. 5 is a rear view of the terminal block illustrated in FIG. 1;

FIG. 6 is a rear view of the terminal block illustrated in FIG. 2;

FIG. 7 is a side view of the cover illustrated in FIG. 3;

FIG. 8 is a cross-sectional view taken along line A-A in FIG. 5 in the aspect in FIG. 1;

FIG. 9 is a cross-sectional view taken along line A-A in FIG. 5 in the aspect in FIG. 2;

FIG. 10 is a cross-sectional view taken along line A-A in FIG. 5 in an aspect in which other covers are in open positions; and

FIG. 11 is a cross-sectional view taken along line A-A in FIG. 5 in an aspect in which other covers are in open positions.

### DESCRIPTION OF EMBODIMENTS

Hereinafter, a terminal block 1 according to an embodiment of the present disclosure will be described with reference to the drawings.

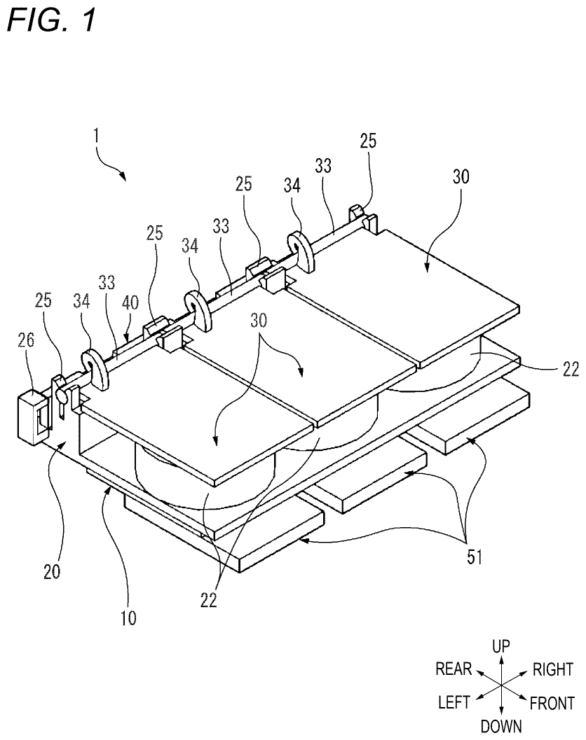

Hereinafter, for convenience of description, as illustrated in FIG. 1 or the like, “front”, “rear”, “left”, “right”, “up”, and “down” are defined. A “front-rear direction”, a “left-right direction”, and an “up-down direction” are orthogonal to each other. The left-right direction corresponds to an “axial direction” in the present disclosure. A direction in which a cover 30 pivots from a closed position toward an open position is referred to as an “opening direction”, and a direction in which the cover 30 pivots from the open position toward the closed position is referred to as a “closing direction”.

A terminal block 1 is provided in, for example, an electrical device (not illustrated), and conductively connects a terminal 10 in the electrical device to a counterpart terminal 51 to connect the electrical device and a counterpart electrical device.

The terminal block 1 includes a plurality of terminals 10 connected to the counterpart terminals 51, a housing 20 provided with a plurality of (three in this example) opening tubes 22 corresponding to the plurality of (three in this example) terminals 10, a plurality of (three in this example) covers 30 pivotally supported by the housing 20, each having a pivot shaft and configured to be pivotable around the pivot shaft between open positions and closed positions with respect to each of the plurality of opening tubes 22, and a restriction member 40 accommodated in the housing 20 and restricts, in response to pivoting of one cover 30 as a first cover among the plurality of covers 30 in an opening direction, pivoting of a plurality of (two in this example) other covers 30, except for the one cover 30, among the plurality of covers 30 in the opening direction. Hereinafter, the terminal 10, the housing, the cover 30, and the restriction member 40 that constitute the terminal block 1 will be described in this order.

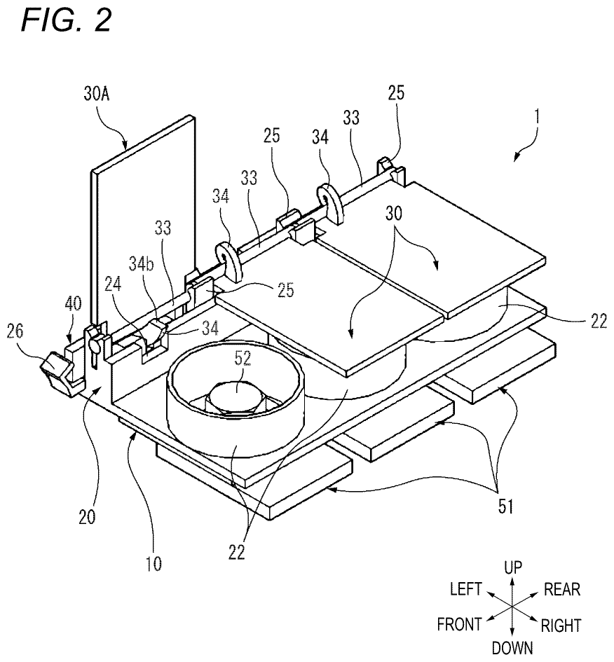

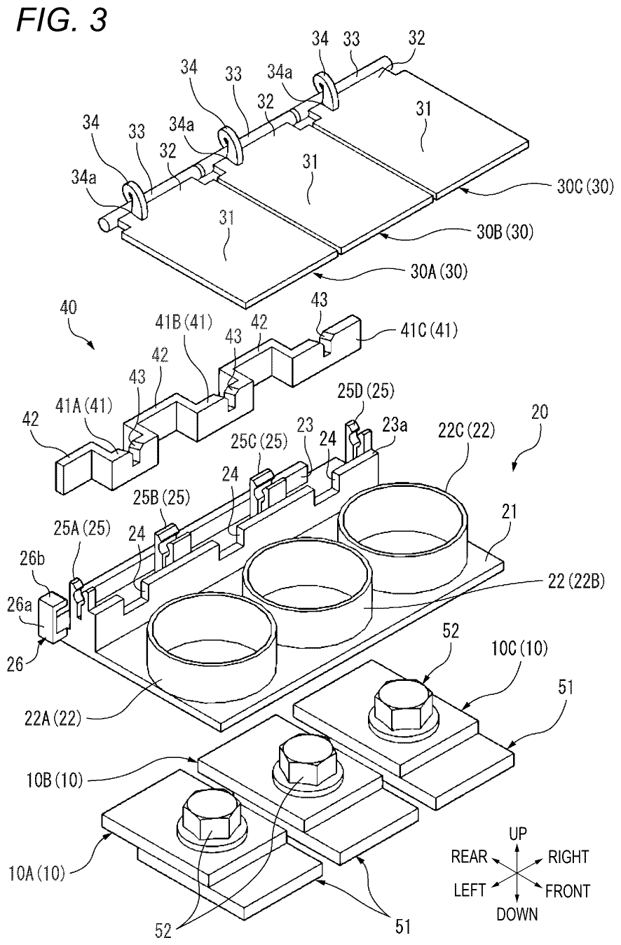

First, the terminal 10 will be described. As illustrated in FIG. 3, the terminal 10 is formed of, for example, a conductive plate-shaped member. The terminal 10 is provided with a bolt through hole (reference sign omitted) that penetrates in the up-down direction, and a bolt 52 is inserted into the bolt through hole when the terminal 10 and the counterpart terminal 51 are connected (see FIGS. 2 to 3).

Next, the housing 20 will be described. The housing 20 includes a housing body 21 provided with the opening tubes 22 that penetrate in the up-down direction. The opening tubes 22 (22A to 22C) are operation openings for the terminals 10 (10A to 10C) connected to the counterpart terminals 51, and are disposed corresponding to each of the terminals 10.

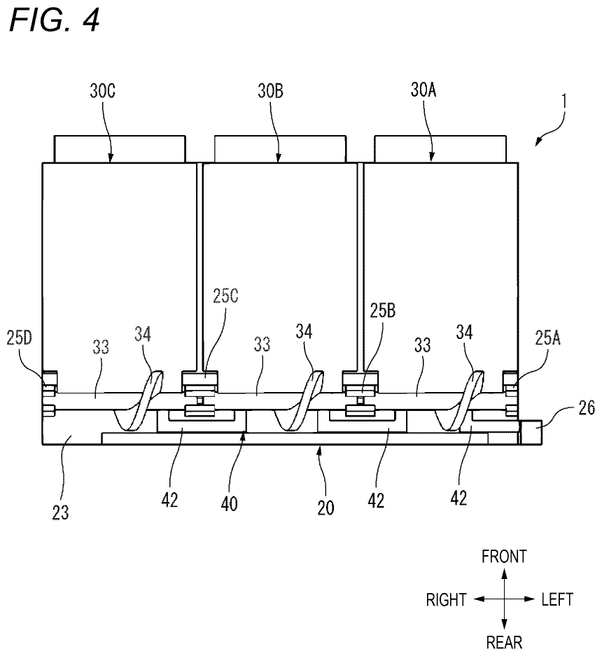

As illustrated in FIGS. 3 and 4, a rear end of the housing body 21 is provided with an accommodating portion 23 that accommodates the restriction member 40. A front wall portion 23a and a rear wall portion (reference sign omitted) of the accommodating portion 23 define an accommodating space at the rear end of the housing body 21.

As illustrated in FIGS. 2 to 3, the front wall portion 23a is formed with a plurality of (three in this example) notches 24 that correspond to each of meshing portions 34 of the plurality of covers 30, which will be described later. The notch 24 has a groove shape in which an upper face of the front wall portion 23a is cut out downward, and is formed not to obstruct by or contacted with the meshing portion 34 when the cover 30 pivots (see FIGS. 2 and 9 to 11).

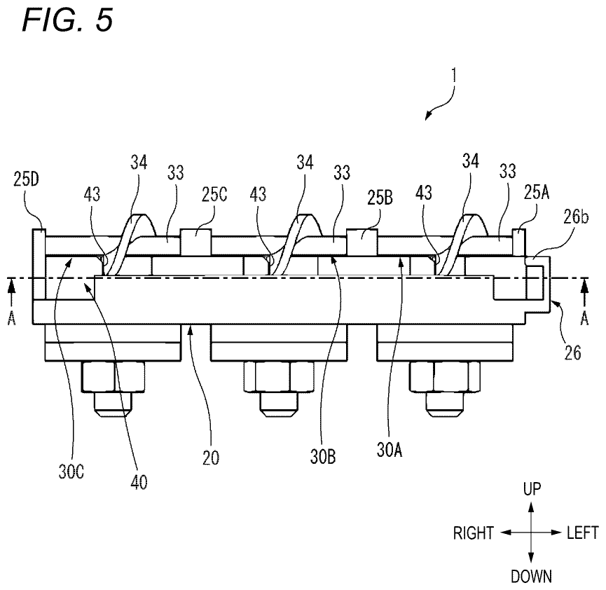

The accommodating portion 23 is provided with a plurality of (four in this example) bearing portions 25 that correspond to the plurality of covers 30 and pivotably support pivot shafts 33 of the plurality of covers 30 respectively, which will be described later. In this example, a pair of bearing portions 25A, 25B pivotally support a cover 30A, a pair of bearing portions 25B, 25C pivotally support a cover 30B, and a pair of bearing portions 25C, 25D pivotally support a cover 30C (see FIGS. 4 to 6).

As illustrated in FIGS. 1 to 6 and 8 to 11, a left end portion of the accommodating portion 23 is provided with an elastic portion 26 that pushes the restriction member 40 back to 20 the initial position (see FIGS. 1, 4, 5, and 8) when the one cover 30 is displaced from the open position to the closed position, and all of the plurality of covers 30 are in the closed positions, as will be described later.

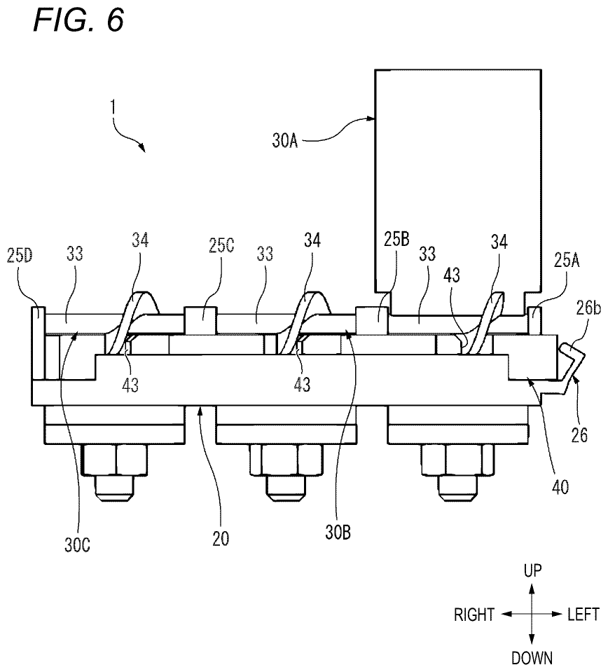

As illustrated in FIG. 3, the elastic portion 26 is formed in a cantilever shape in which an elastic section 26a that extends in the up-down direction and a contact portion 26b that extends rightward from an upper end of the elastic section 26a are integrally formed. The elastic portion 26 is elastically deformed at the elastic section 26a and comes into contact with the restriction member 40 at the contact portion 26b. Accordingly, as will be described later, the elastic portion 26 elastically comes into contact with the restriction member 40 (see FIGS. 6 and 9 to 11) when one cover is in the open position, and is restored and deformed when the elastic portion 26 pushes restriction member 40 back to the initial position.

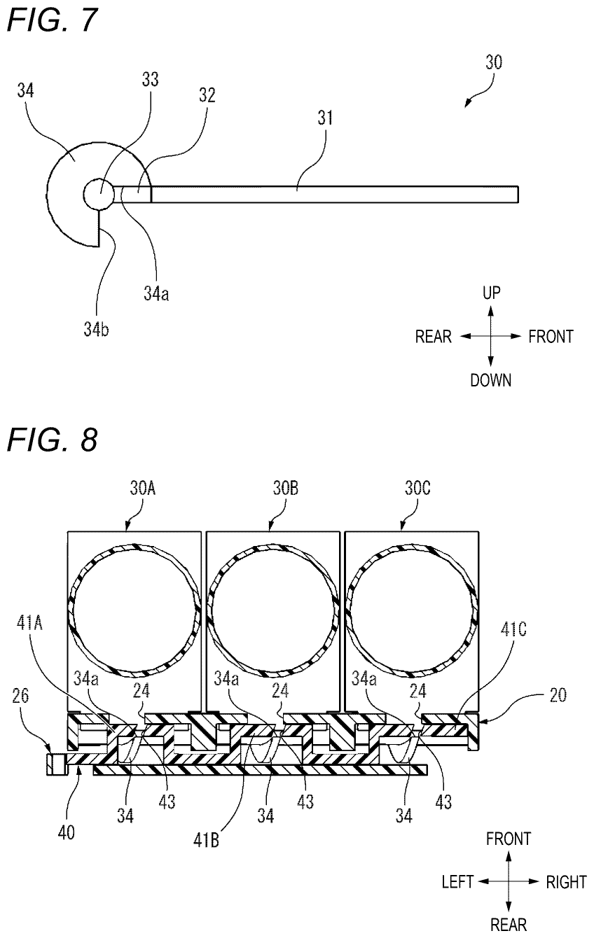

Next, the cover 30 will be described. As illustrated in FIGS. 3 and 7, the cover 30 includes a substantially rectangular plate-shaped cover body 31. As illustrated in FIGS. 3 and 7, the cover body 31 is formed by cutting out both left and right side walls of a rear end portion 32 thereof inward, and the rear end portion 32 of the cover body 31 is provided with a pivot shaft 33 that extends in the left-right direction and is pivotally supported by bearing portion 25 respectively.

The pivot shaft 33 is provided with the meshing portion 34 formed in a spiral shape corresponding to pivoting of the cover 30 around the pivot shaft 33. The meshing portion 34 is able to mesh with a meshed portion 43 of the restriction member 40, which will be described later. The restriction member 40 allows the cover 30 to pivot from the closed position to the open position only when the meshing portion 34 meshes with the meshed portion 43.

As illustrated in FIGS. 3 and 7, one end portion 34a of the meshing portion 34, formed in a spiral shape, is formed integrally with the rear end portion 32 of the cover body 31, and the other end portion 34b thereof is formed to be disposed behind a rear end surface of a convex portion 41 of the restriction member 40, which will be described later, when the cover 30 is in the closed position (see FIGS. 8 to 11). Since the meshing portion 34 is formed in a spiral shape, the other end portion 34b is positioned to the right with respect to the one end portion 34a.

Next, the restriction member 40 will be described. The restriction member 40 integrally includes a plurality of (three in this example) convex portions 41 (41A to 41C) that are convex toward the front and a plurality of (three in this example) concave portions 42 that are concave toward the front, and the convex portions 41 and the concave portions 42 are alternately connected in the left-right direction.

As will be described later, the convex portion 41 has a function of restricting, in response to the pivoting of one cover 30 among the plurality of covers 30 in the opening direction, the pivoting of the plurality of covers 30 other than the one cover 30 in the opening direction. The concave portion 42 is formed such that the restriction member 40 is not obstructed by or contacted with the bearing portion 25 in the accommodating portion 23.

The convex portion 41 is provided with the meshed portion 43 that corresponds to the meshing portion 34 of the cover 30 and is able to mesh with the meshing portion 34. The meshed portion 43 is formed in a groove shape in which an upper face of the convex portion 41 is cut out downward. When the meshing portion 34 meshes with the meshed portion 43, the cover 30 is pivotable. Further, when the meshed portion 43 meshes with the meshing portion 34, the restriction member 40 is displaced in the left-right direction (specifically, leftward) in response to the pivoting of the cover 30.

In this example, a position where the restriction member 40 is accommodated in the accommodating portion 23 is the initial position. When the restriction member 40 is positioned in the initial position, all of the plurality of covers 30 are positioned in the closed positions (see FIGS. 1, 4, 5, and 8). Further, when the restriction member 40 is positioned in the initial position, the meshing portions 34 of the plurality of covers 30 are in a state of being able to mesh with the meshed portions 43 respectively (see FIG. 8).

The terminal 10, the housing, the cover 30, and the restriction member 40 that constitute the terminal block 1 have been described above. Hereinafter, a restriction structure in the terminal block 1 (that is, a structure that prevents the pivoting of the other covers 30 when the one cover 30 pivots or is in the open position) will be described. In the following description, the left cover 30A is referred to as “one cover (first cover)”, and the center cover 30B and the right cover 30C are referred to as “a plurality of other covers (a plurality of the covers other than the first cover)”.

First, before describing the restriction structure in the terminal block 1, it is necessary to pivot the cover 30A from the closed position to the open position. At this time, since all of the plurality of covers 30 are positioned in the closed positions, the restriction member 40 is positioned in the initial position, and the meshing portions 34 of the plurality of covers 30 is in a state of being able to mesh with the meshed portions 43 (see FIG. 8) respectively.

Initially, when the cover 30A is lifted and pivots to the opening direction, the meshing portion 34 of the cover 30A meshes with the meshed portion 43 of the convex portion 41A in the restriction member 40 at the time of lifting or the beginning of the pivoting. Then, in this state, the cover 30A pivots to the open position. At this time, the restriction member 40 is displaced leftward from the initial position in response to the pivoting of the cover 30 due to meshing of the meshing portion 34, which is formed in a spiral shape, with the meshed portion 43. Further, when the restriction member 40 is displaced leftward from the initial position, the restriction member 40 pushes the elastic portion 26 leftward, so that the elastic section 26a of the elastic portion 26 is elastically deformed, and a left end face of the restriction member 40 elastically comes into contact with the contact portion 26b of the elastic portion 26 (see FIGS. 2, 6, and 9).

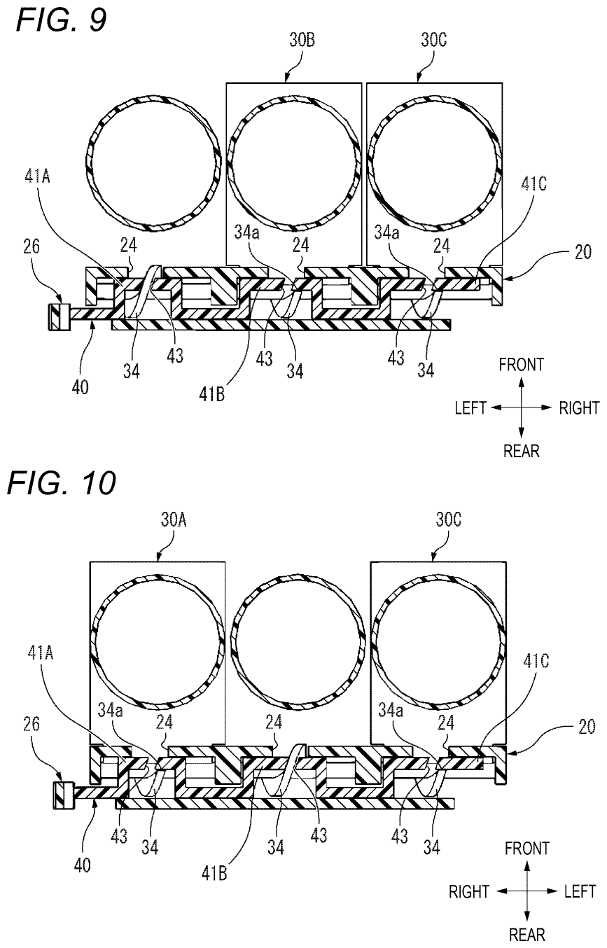

In this way, in response to pivoting of the cover 30A in the opening direction, the restriction member 40 is displaced leftward from the initial position, and the meshed portions 43 of the convex portions 41B, 41C are also displaced leftward, so that the meshing portions 34 of the covers 30B, 30C and the meshed portions 43 of the convex portions 41B, 41C are misaligned and unable to mesh with each other (see FIGS. 6 and 9).

More specifically, when the covers 30B, 30C pivot in the opening direction in a state in which the restriction member 40 is displaced leftward from the initial position, the other end portions 34b of the meshing portions 34 of the covers 30B, 30C are obstructed by or contacted with rear end surfaces of the convex portions 41B, 41C, and pivoting of the covers 30B, 30C is restricted by the restriction member 40.

Similarly, when the cover 30B pivots or is positioned in the open position, the meshing portions 34 of the covers 30A, 30C and the meshed portions 43 of the convex portions 41A, 41C are misaligned and unable to mesh with each other, and when the covers 30A, 30C pivot in the opening direction, the other end portions 34b of the meshing portions 34 of the covers 30A, 30C are obstructed by or contacted with rear end surfaces of the convex portions 41A, 41C, and pivoting of the covers 30A, 30C is restricted by the restriction member 40 (see FIG. 10).

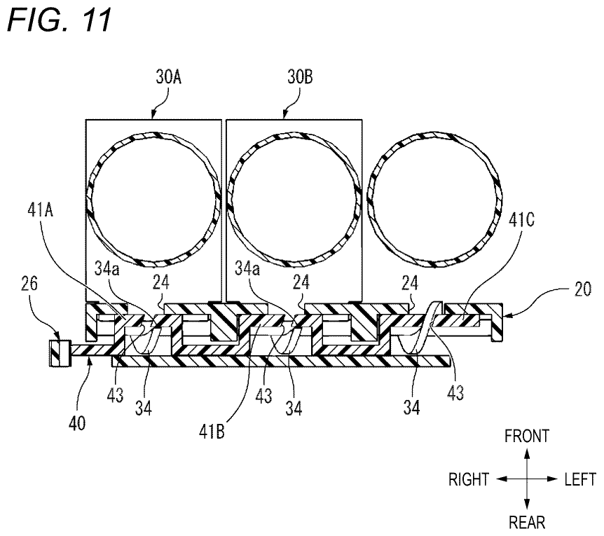

Further, similarly, when the cover 30C pivots or is positioned in the open position, the meshing portions 34 of the covers 30A, 30B and the meshed portions 43 of the convex portions 41A, 41B are misaligned and unable to mesh with each other, and when the covers 30A, 30B pivot in the opening direction, the other end portions 34b of the meshing portions 34 of the covers 30A, 30B are obstructed by or contacted with rear end surfaces of convex portions 41A, 41B, and pivoting of the covers 30A, 30B is restricted by the restriction member 40 (see FIG. 11).

As described above, when one cover 30 pivots or is positioned in the open position, the plurality of other covers 30 are appropriately prevented from pivoting by the restriction member 40.

When the cover 30 in the open position pivots in the closing direction to return to the closed position, the restriction member 40 is displaced from a displaced position thereof to a position immediately before the initial position in response to the pivoting of the cover 30 due to the meshing of the meshing portion 34 with the meshed portion 43. When the cover 30 reaches the closed position, the restriction member 40 is pushed back to the initial position from the position immediately before the initial position by an elastic force due to restoring deformation of the elastic portion 26. Accordingly, the meshing portions 34 of the plurality of covers 30 are in a state of being able to mesh with the meshed portions 43 (see FIG. 8) respectively. The restriction structure of the terminal block 1 has been described above.

As described above, according to the present embodiment, when all of the plurality of covers 30 are positioned in the closed position to close the opening tubes 22, the restriction member 40 is positioned in the initial position where each of the meshed portions 43 of the restriction member 40 are able to mesh with the meshing portion 34 of the plurality of covers 30, and when one cover 30 pivots in the opening direction, the meshing portion 34 of the one cover 30 meshes with the meshed portion 43 corresponding thereto, and in response to the pivoting of the one cover 30 from the closed position to the open position, the restriction member 40 is displaced leftward from the initial position, making each of the meshing portions 34 of the plurality of other covers 30 unable to mesh with the meshed portion 43 corresponding thereto. Since the cover 30 is pivotable from the closed position to the open position only when the meshing portion 34 meshes with the meshed portion 43, the plurality of other covers 30 cannot pivot from the closed position to the open position. That is, according to the present embodiment, when one cover 30 is opened or is opening, the other covers 30 can be appropriately prevented from opening.

Further, according to the present embodiment, since the meshing portion 34 is formed in a spiral shape corresponding to the pivoting of the cover 30 around the pivot shaft 33, the restriction member 40 is displaced in the left-right direction from the initial position in response to the pivoting of the cover 30 from the closed position to the open position due to the meshing of the meshing portion 34 with the meshed portion 43. In this way, according to the present embodiment, the restriction member 40 can be displaced in the left-right direction from the initial position with a simple structure.

Furthermore, according to the present embodiment, when the plurality of other covers 30 pivot in the opening direction in a state in which the restriction member 40 is displaced in the axial direction from the initial position, the meshing portions 34 of the plurality of other covers 30 are obstructed by or contacted with the restriction member 40, and thus the plurality of other covers 30 cannot pivot from the closed positions to the open positions.

Furthermore, according to the present embodiment, the housing 20 is provided with the elastic portion 26 that elastically comes into contact with the restriction member 40 when the one cover 30 is in the open position, and pushes the restriction member 40 back to the initial position when the one cover 30 is displaced from the open position to the closed position and all of the plurality of covers 30 are in the closed positions. Accordingly, after an operation on one terminal 10 via the opening tube 22 corresponding to the one cover 30 is completed, the one cover 30 is returned to the closed position, so that the restriction member 40 is pushed back to the initial position by the elastic portion 26, allowing for easy transition to operations on other terminals 10 via the opening tubes 22 corresponding to the other covers 30.

The present disclosure is not limited to the above embodiment, and modifications, improvements, or the like can be made as appropriate. In addition, materials, shapes, dimensions, numbers, disposition positions, and the like of components in the above embodiment are freely selected and are not limited as long as the present disclosure can be implemented.

Here, features of the embodiment of the terminal block according to the present disclosure described above are briefly summarized and listed in the following [1] to [4].

### 1

A terminal block (1) including:
a plurality of terminals (10) connected to counterpart terminals (51);
a housing (20) provided with a plurality of openings (opening tubes 22) corresponding to the plurality of terminals (10);
a plurality of covers (30) pivotally supported by the housing (20), each having a pivot shaft (33) and configured to be pivotable around the pivot shaft (33) between an open position and a closed position with respect to each of the plurality of openings (opening tubes 22); and
a restriction member (40) accommodated in the housing (20) and configured to restrict, in response to pivoting of a first cover (30) of the plurality of the covers (30) in an opening direction, pivoting of the plurality of the covers (30) other than the first cover (30) in the opening direction, in which
a meshing portion (34) is provided on the pivot shaft (33), the meshing portion (34) configured to mesh with each of a plurality of meshed portions (43) provided on the restriction member (40), only when the meshing portion (34) meshes with the meshed portion (43), the plurality of the covers (30) are pivotable from the closed position to the open position,
when all of the plurality of the covers (30) are in the closed positions, the restriction member (40) is positioned in an initial position where each of the plurality of meshed portions (43) is able to mesh with the meshing portion (34), and
when the first cover (30) pivots in the opening direction, the meshing portion (34) of the first cover (30) meshes with the meshed portion (43), and in response to the pivoting of the first cover (30) from the closed position to the open position, the restriction member (40) is displaced in an axial direction (left-right direction) of the pivot shaft (33) from the initial position, thereby making the meshing portion (34) in the plurality of the covers (30) other than the first cover (30) unable to mesh with the meshed portion (43).

According to the configuration in the above [1], when all of the plurality of covers are in the closed positions to close the openings, the restriction member is positioned in the initial position where each of the plurality of meshed portions is able to mesh with the meshing portion, and when the first cover pivots in the opening direction, the meshing portion of the first cover meshes with the meshed portion, and in response to the first cover pivoting from the closed position to the open position, the restriction member is displaced in an axial direction of the pivot shaft from the initial position, thereby making the meshing portions of the plurality of the covers other than the first cover unable to mesh with the meshed portion. Since the cover is pivotable from the closed position to the open position only when the meshing portion meshes with the meshed portion, the plurality of covers other than the first cover cannot pivot from the closed positions to the open positions. That is, according to this configuration, when the first cover is opened or is opening, the covers other than the first cover can be appropriately prevented from opening.

[2] The terminal block (1) according to the above [1], in which
the meshing portion (34) is formed in a spiral shape corresponding to the pivoting of the cover (30) around the pivot shaft (33).

According to the configuration in the above [2], since the meshing portion is formed in a spiral shape corresponding to the pivoting of the cover around the pivot shaft, the restriction member is displaced in the axial direction of the pivot shaft from the initial position in response to pivoting of the first cover from the closed position to the open position due to the meshing of the meshing portion with the meshed portion. In this way, according to this configuration, the restriction member can be displaced in the axial direction from the initial position with a simple structure.

[3] The terminal block (1) according to the above [1], in which

when the plurality of the covers (30) other than the first cover (30) pivot in the opening direction in a state in which the restriction member (40) is displaced in the axial direction from the initial position, the meshing portions (34) in the plurality of the covers (30) other than the first cover (30) are contacted with the restriction member (40) to restrict the pivoting of the plurality of the covers (30) other than the first cover (30) in the opening direction.

According to the configuration in the above [3], when the plurality of covers other than the first cover pivot in the opening direction in a state in which the restriction member is displaced in the axial direction from the initial position, the meshing portions of the plurality of covers other than the first cover are contacted with the restriction member, and thus the plurality of covers other than the first cover cannot pivot from the closed positions to the open positions.

[4] The terminal block (1) according to the above [1], in which
an elastic portion (26) is provided on the housing (20), the elastic portion (26) elastically coming into contact with the restriction member when the first cover (30) is in the open position, and pushing the restriction member (40) back to the initial position when the first cover (30) is displaced from the open position to the closed position and all of the plurality of covers (30) are in the closed positions. 5

According to the configuration in the above [4], the elastic portion is provided on the housing, the elastic portion elastically coming into contact with the restriction member when the first cover is in the open position, and pushing the restriction member back to the initial position when the first cover is displaced from the open position to the closed position and all 10 of the plurality of covers are in the closed positions. Accordingly, after an operation on one terminal via the opening corresponding to the first cover is completed, the one cover is returned to the closed position, so that the restriction member is pushed back to the initial position by the elastic portion, allowing for easy transition to operations on other terminals via the openings corresponding to the plurality of covers other than the first cover.

What is claimed is:

1. A terminal block comprising:
a plurality of terminals connected to counterpart terminals;
a housing provided with a plurality of openings corresponding to the plurality of terminals;
a plurality of covers pivotally supported by the housing, each having a pivot shaft and configured to be pivotable around the pivot shaft between an open position and a closed position with respect to each of the plurality of openings; and
a restriction member accommodated in the housing and configured to restrict, in response to pivoting of a first cover of the plurality of the covers in an opening direction, pivoting of the plurality of the covers other than the first cover in the opening direction, wherein
a meshing portion is provided on the pivot shaft, the meshing portion configured to mesh with each of a plurality of meshed portions provided on the restriction member,
only when the meshing portion meshes with the meshed portion, the plurality of the covers are pivotable from the closed position to the open position,
when all of the plurality of the covers are in the closed positions, the restriction member is positioned in an initial position where each of the plurality of meshed portions is able to mesh with the meshing portion, and
when the first cover pivots in the opening direction, the meshing portion of the first cover meshes with the meshed portion, and in response to the pivoting of the first cover from the closed position to the open position, the restriction member is displaced in an axial direction of the pivot shaft from the initial position, thereby making the meshing portion in the plurality of the covers other than the first cover unable to mesh with the meshed portion.

2. The terminal block according to claim 1, wherein
the meshing portion is formed in a spiral shape corresponding to the pivoting of the cover around the pivot shaft.

3. The terminal block according to claim 1, wherein
when the plurality of the covers other than the first cover pivot in the opening direction in a state in which the restriction member is displaced in the axial direction from the initial position, the meshing portions in the plurality of the covers other than the first cover are contacted with the restriction member to restrict the pivoting of the plurality of the covers other than the first cover in the opening direction.

4. The terminal block according to claim 1, wherein
an elastic portion is provided on the housing, the elastic portion elastically coming into contact with the restriction member when the first cover is in the open position, and pushing the restriction member back to the initial position when the first cover is displaced from the open position to the closed position and all of the plurality of covers are in the closed positions.
